(19) United States
(12) Patent Application Publication
(10) Pub. No.: US 2026/0266349 A1
(43) Pub. Date: Sep. 10, 2026

(54) SPRING MEMBER, CAMERA MODULE, AND ELECTRONIC DEVICE

(71) Applicant: TOPPAN Holdings Inc., Tokyo (JP)

(72) Inventors: Teppei WATANABE, Tokyo (JP); Taiji MIYATA, Tokyo (JP); Kazuma USUI, Tokyo (JP); Norihiko OSHIMA, Tokyo (JP)

(73) Assignee: TOPPAN Holdings Inc., Tokyo (JP)

(21) Appl. No.: 19/661,734

(22) Filed: Apr. 29, 2026

Related U.S. Application Data
(63) Continuation of application No. PCT/JP2025/016294, filed on Apr. 28, 2025.

(30) Foreign Application Priority Data
Apr. 30, 2024 (JP) 2024-073654

(51) Int. Cl. F16F 3/02

(52) U.S. Cl. CPC F16F 3/023; F16F 2224/0208; F16F 2238/022

(57) ABSTRACT

A spring member has a first surface and a second surface opposite the first surface. The spring member further has, in a cross section perpendicular to the first surface, three or more fine wires. Among the three or more fine wires, the fine wires located at both edges are outer fine wires and the fine wire located between the outer fine wires is an inner fine wire. The inner fine wire has a width of 10 μm or more on each of the first and second surfaces. On the first and second surfaces, the outer fine wires have widths that are greater than the width of the inner fine wire by 2 μm or more and 8 μm or less.

### CROSS-REFERENCE TO RELATED APPLICATIONS

This application is a continuation of PCT Application No. PCT/JP2025/016294, filed Apr. 28, 2025, which claims the benefit of priority from Japanese Patent Application No. 2024-073654, filed Apr. 30, 2024, the contents of each are incorporated by reference in their entirety herein.

### TECHNICAL FIELD

The present disclosure relates to spring members for camera modules, camera modules, and electronic devices.

### BACKGROUND ART

Camera modules used in electronic devices with cameras, such as tablet terminals and smartphones, have drive mechanisms that enable autofocus and zoom. Known types of drive mechanisms include the lens drive type and the sensor drive type. Lens drive-type drive mechanisms include a spring member that enables the position of the lens to be changed in the direction of the optical axis of the lens. On the other hand, sensor drive-type drive mechanisms include a spring member that enables the position of the image sensor to be changed in the optical axis direction of the lens (see, for example, PTL 1 and PTL 2).

### CITATION LIST

### Patent Literature

PTL 1: JP 2014-059345 A

PTL 2: JP 2020-170170 A

### SUMMARY OF THE INVENTION

### Technical Problem

Spring members include first spring members having spring portions of a folded line-shape when viewed from a direction perpendicular to the plane in which the spring members extend, and second spring members having spring portions each composed of a plurality of independent springs. Each spring portion connects an inner frame portion to an outer frame portion.

Whether the spring portion is provided in a first spring member or a second spring member, a spring portion includes a plurality of fine wires arranged at intervals in a plane perpendicular to the plane in which the spring member extends and perpendicular to the direction in which the spring portion extends.

The fine wires include a pair of outer fine wires located at the edges in the direction in which the fine wires are arranged, and one or more inner fine wires located between the outer fine wires. From the perspective of miniaturizing the spring portions, it is desired that the intervals between the fine wires be narrow. On the other hand, in order to enable the spring portions to be driven, certain distances are required between the spring portions and the outer frame portion, and between the spring portions and the inner frame portion.

The spring members are formed by wet etching of a metal foil. The resist mask used for wet etching of the metal foil has openings corresponding to the gaps between the fine wires and openings corresponding to the gaps between the spring portions and the respective frame portions. The openings corresponding to the gaps between each spring portion and the respective frame portions have a larger width than the openings corresponding to the gaps between the fine wires. Therefore, less etching solution is likely to reach the openings corresponding to the gaps between the fine wires, while more etching solution is likely to reach the openings corresponding to the gaps between each spring portion and the respective frame portions.

Therefore, of the pair of side surfaces of each outer fine wire that face each other in the direction in which the fine wires are arranged, the side surface that is farther away from the inner fine wires tends to have a shape that is deeply hollowed out near the center in the thickness direction of the spring member, compared to the side surfaces of the inner fine wires. As a result, during wet etching of the metal foil, a local penetrating portion that penetrates across the pair of side surfaces may be formed in an outer fine wire near the center in the thickness direction of the spring member, and the outer fine wire may break if the etching progresses further.

### Solution to Problem

A spring member for a camera module for solving the above problems includes: a first surface; and a second surface opposite the first surface. The spring member further includes, in a cross section perpendicular to the first surface, three or more fine wires, among which the fine wires located at both edges are outer fine wires and the fine wire located between the outer fine wires is an inner fine wire. The inner fine wire has a width of 10 μm or more on each of the first and second surfaces. On the first and second surfaces, the outer fine wires have widths that are greater than the width of the inner fine wire by 2 μm or more and 8 μm or less.

According to the above spring member, since the inner fine wire has a width of 10 μm or more on each surface and the outer fine wires have a width that is greater than the width of the inner fine wire by 2 μm or more on each surface, it is possible to suppress the occurrence of a local penetrating portion or breakage near the centers of the inner and outer fine wires in the thickness direction during etching. In addition, since the inner fine wire has a width of 10 μm or more on each surface and the outer fine wires have a width that is greater than the width of the inner fine wire by 8 μm or less on each surface, the concentration of load on the inner fine wire caused by driving the spring member can be suppressed. As a result, it is possible to suppress the deformation of the inner fine wire caused by driving the spring member.

In the above spring member, the width of each fine wire on the first surface may be a first width and the width of each fine wire on the second surface may be a second width, and the first and second widths may be the first or second largest width in a thickness direction of the spring member.

According to the above spring member, it is possible to prevent each fine wire from becoming excessively rigid compared to when their portion on the inner side of the first and second widths in the thickness direction of the spring member is thicker than the first and second widths.

In the above spring member, the first and second widths of each fine wire may be 20 μm or less.

According to the above spring member, it is possible to enhance the effects obtained when, on each surface, the inner fine wire has a width of 10 μm or more and the outer fine wires have a width that is greater than the width of the inner fine wire by 2 μm or more and 8 μm or less.

In the spring member, each outer fine wire may have a pair of side surfaces extending in a thickness direction of the spring member, namely, a first side surface at a smaller distance from the inner fine wire and a second side surface opposite the first side surface, and the second side surface may be V-shaped and recessed from the second side surface toward the first side surface.

According to the above spring member, since each outer fine wire is narrowed on at least one side surface, the rigidity of the outer fine wires is unlikely to be excessively high.

In the above spring member, the fine wires may have an aspect ratio of 3 or greater and 20 or less. According to the above spring member, it is possible to suppress the occurrence of a local penetrating portion in or breakage of the fine wires in the thickness direction during etching and to suppress deformation of the fine wires during driving, over a wide range of aspect ratios of the fine wires.

In the above spring member, the spring member may have a thickness of 120 μm or more and 200 μm or less.

According to the above spring member, it is possible to ensure that the effects resulting from the fine wires satisfying the above conditions are obtained.

In the above spring member, the spring member may contain any selected from the group consisting of a stainless steel alloy, beryllium copper, a copper-nickel-tin alloy, phosphor bronze, a Corson alloy, and titanium copper.

According to the above spring member, since the spring member can have high hardness, the durability of the spring member can be improved.

In the above spring member, the spring member may include a base metal containing any selected from the group consisting of a stainless steel alloy, beryllium copper, a copper-nickel-tin alloy, phosphor bronze, a Corson alloy, and titanium copper, and the base metal may have a first surface and a second surface opposite the first surface, and the spring member may further include a copper layer on at least one of the first and second surfaces of the base metal.

### Advantageous Effects of the Invention

According to the present disclosure, it is possible to achieve both suppression of the occurrence of a local penetrating portion or breakage near the center of each fine wire in the thickness direction during etching, and suppression of deformation of the fine wires caused by driving the spring member.

### BRIEF DESCRIPTION OF THE DRAWINGS

FIG. 1 is a plan view showing the structure of a spring member.

FIG. 2 is a cross-sectional view of the structure taken along the line II-II in FIG. 1.

FIG. 3(A) to 3(C) are cross-sectional views each showing an example of the structure of an inner fine wire.

FIG. 4(A) to 4(C) are cross-sectional views each showing an example of the structure of an outer fine wire.

FIG. 5 illustrates a step in a method for manufacturing the spring member.

FIG. 6 illustrates a step in the method for manufacturing the spring member.

FIG. 7 illustrates a step in the method for manufacturing the spring member.

FIG. 8 illustrates a step in the method for manufacturing the spring member.

FIG. 9 illustrates a step in the method for manufacturing the spring member.

FIG. 10 is a schematic plan view showing the shapes of resist masks.

FIG. 11 is a table showing evaluation results of Examples and Comparative Examples.

FIG. 12 is a table showing evaluation results of Examples and Comparative Examples.

FIG. 13 is a table showing evaluation results of Examples and Comparative Examples.

### DESCRIPTION OF THE EMBODIMENTS

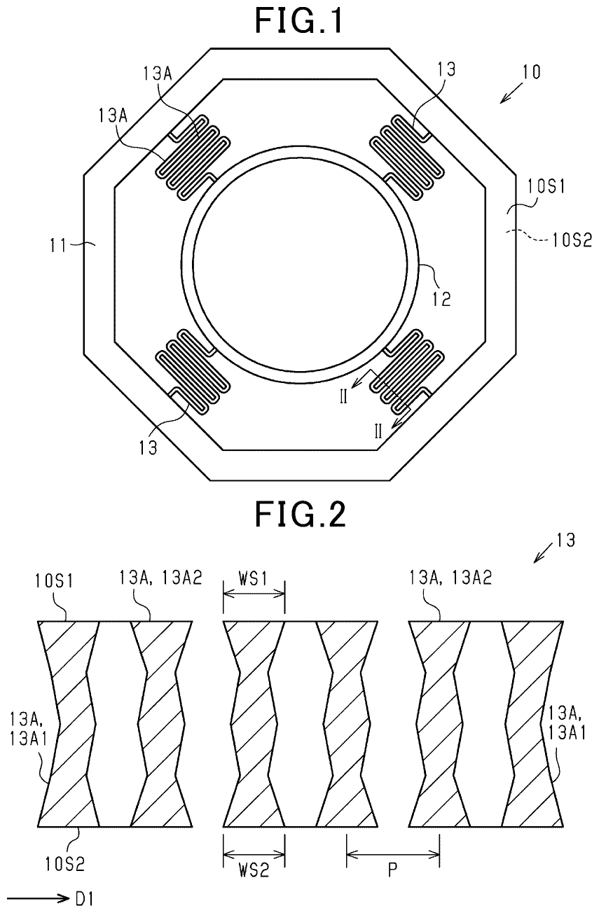

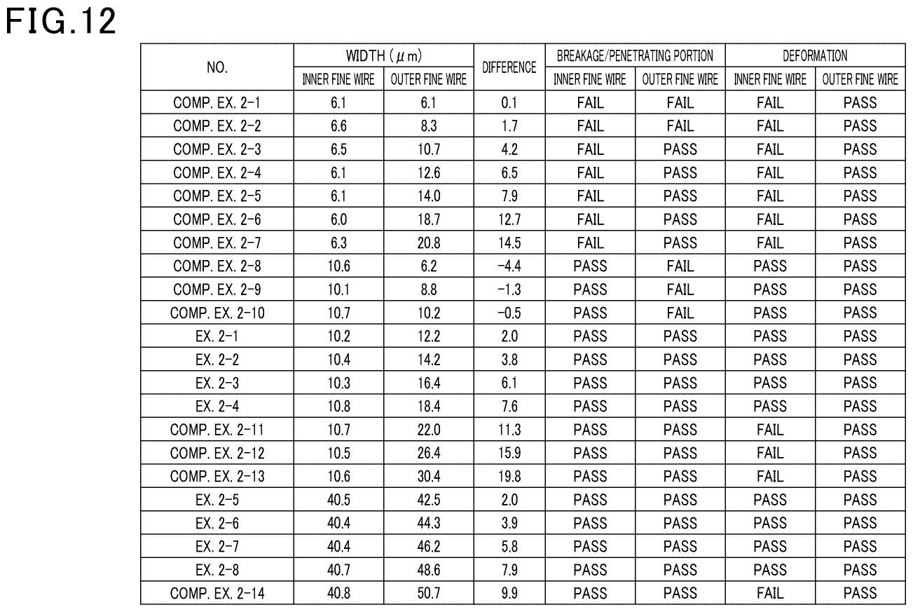

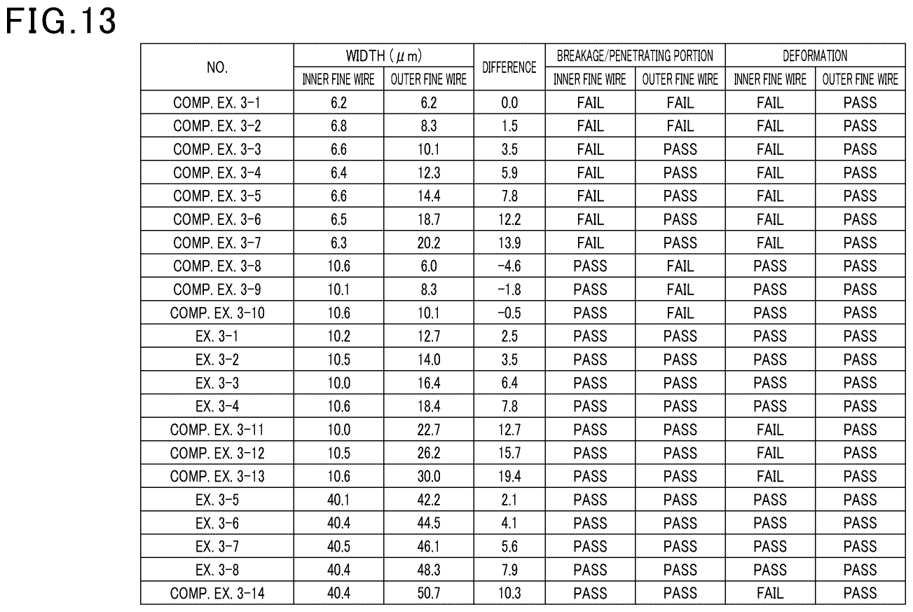

Embodiments of a spring member for a camera module, a camera module, and an electronic device will be described with reference to FIGS. 1 to 13.

### Spring Member for Camera Module

A spring member for a camera module will be described with reference to FIGS. 1 to 4. FIG. 1 shows a schematic planar structure of a spring member as viewed from a direction perpendicular to the plane in which the spring member extends.

As shown in FIG. 1, a spring member 10 for a camera module includes a first surface 10S1 and a second surface 10S2 opposite to the first surface 10S1. The first and second surfaces 10S1 and 10S2 are a pair of surfaces facing away from each other in the thickness direction of the spring member 10. The spring member 10 includes an outer frame portion 11, an inner frame portion 12, and spring portions 13. The spring portions 13 are leaf springs.

Each spring portion 13 includes a plurality of fine wires 13A. When viewed from a direction perpendicular to the plane in which the spring member 10 extends, each fine wire 13A extends straight along the plane in which the spring member 10 extends. Each fine wire 13A is part of the metal foil that forms the spring member 10, and adjacent fine wires 13A are connected to each other via bent portions.

In the example shown in FIG. 1, the outer frame portion 11 has an octagonal outer shape, and the inner frame portion 12 has a circular outer shape. The spring portions 13 have a folded line-shape. The outer shape of the outer frame portion 11 and the outer shape of the inner frame portion 12 may be changed according to the shapes of the other components included in the drive mechanism of the camera module in which the spring member 10 is provided, i.e., the components other than the spring member 10. The inner frame portion 12 is located within the area defined by the outer frame portion 11. The spring portions 13 connect the inner frame portion 12 to the outer frame portion 11.

In a lens drive-type drive mechanism, a pair of spring members 10 are arranged on opposite sides of the lens in the optical axis direction of the lens. In the optical axis direction, the position of the inner frame portion 12 connected to the outer frame portion 11 changes relative to the outer frame portion 11, thereby changing the position of the lens in the optical axis direction. This makes it possible to compensate for camera shake using a lens drive-type drive mechanism.

On the other hand, in a sensor drive-type drive mechanism, a pair of spring members 10 are arranged on opposite sides of an imaging sensor in the optical axis direction of the lens. In the optical axis direction, the position of the inner frame portion 12 connected to the outer frame portion 11 changes relative to the outer frame portion 11, thereby changing the position of the imaging sensor in the optical axis direction. This makes it possible to compensate for camera shake using a sensor drive-type driving mechanism.

Examples of the electronic device in which the camera module including the spring member 10 is provided include a mobile phone terminal, a smartphone, a tablet terminal, and a laptop personal computer.

FIG. 2 shows the cross-sectional structure of a spring portion 13 taken along the line II-II in FIG. 1. In other words, FIG. 2 shows the cross-sectional structure of the spring member 10 along a plane that is perpendicular to the first surface 10S1 of the spring member 10 and perpendicular to the direction in which each fine wire 13A extends.

As shown in FIG. 2, in a cross section perpendicular to the first surface 10S1, the spring portion 13 includes three or more fine wires 13A. In this cross section of the fine wires 13A, the fine wires 13A located at both edges in the direction in which the fine wires 13A are arranged are outer fine wires 13A1. The direction in which the fine wires 13A are arranged is a first direction D1. Of the fine wires 13A, the fine wires 13A located between the outer fine wires 13A1 in the first direction D1 are inner fine wires 13A2.

In the example shown in FIG. 2, in a cross section perpendicular to the first surface 10S1, the spring portion 13 includes six fine wires 13A. Accordingly, in the first direction D1, four inner fine wires 13A2 are arranged between the two outer fine wires 13A1. The fine wires 13A are arranged at substantially equal intervals in the first direction D1.

The width of each fine wire 13A on the first surface 10S1 is a first width WS1. The width of each fine wire 13A on the second surface 10S2 is a second width WS2. The inner fine wires 13A2 have a width of 10 μm or more on the first and second surfaces 10S1 and 10S2. In other words, the inner fine wires 13A2 have a first width WS1 of 10 μm or more and a second width WS2 of 10 μm or more.

The outer fine wires 13A1 have a width that is 2 μm or more and 8 μm or less thicker than the width of the inner fine wires 13A2 on the first and second surfaces 10S1 and 10S2. The outer fine wires 13A1 have a first width WS1 greater than the first width WS1 of the inner fine wires 13A2 by 2 μm or more and 8 μm or less. The outer fine wires 13A1 have a second width WS2 greater than the second width WS2 of the inner fine wires 13A2 by 2 μm or more and 8 μm or less.

Accordingly, the spring member 10 of the present disclosure satisfies the following conditions 1 and 2.
(Condition 1) The inner fine wires 13A2 have a width of 10 μm or more on the first and second surfaces 10S1 and 10S2.
(Condition 2) The outer fine wires 13A1 have a width that is 2 μm or more and 8 μm or less thicker than the width of the inner fine wires 13A2 on the first and second surfaces 10S1 and 10S2.

When the spring member 10 satisfies condition 1 and also satisfies the lower limit of condition 2, it is possible to suppress the occurrence of a local penetrating portion or breakage near the centers of the inner and outer fine wires 13A2 and 13A1 in the thickness direction during etching. Furthermore, when the spring member 10 satisfies condition 1 and also satisfies the upper limit of condition 2, the concentration of load on the inner fine wires 13A2 caused by driving the spring member 10 can be suppressed. As a result, it is possible to suppress the deformation of the inner fine wires 13A2 caused by driving the spring member 10.

In each fine wire 13A, the first and second widths WS1 and WS2 may be the first or second largest width in the thickness direction of the spring member 10. In other words, in the thickness direction of the spring member 10, the first and second widths WS1 and WS2 are greater than or equal to the width of the fine wire 13A other than the first and second widths WS1 and WS2. In the thickness direction of the spring member 10, the first and second widths WS1 and WS2 of each fine wire 13A are larger than the width of the portion located between the first and second width WS1 and WS2. In this case, it is possible to prevent each fine wire 13A from becoming excessively rigid compared to when their portion on the inner side of the first and second widths WS1 and WS2 in the thickness direction of the spring member 10 is thicker than the first and second widths WS1 and WS2.

The first and second widths WS1 and WS2 of each fine wire 13A may be 20 μm or less. The width at any portion of each fine wire 13A in the thickness direction of the spring member 10 may be 20 μm or less. When the upper limit of the first and second widths WS1 and WS2 of each fine wire 13A is 20 μm or less, the effects obtained when the widths of the fine wires 13A satisfy the conditions 1 and 2 can be enhanced. The upper limit of the first and second widths WS1 and WS2 of each fine wire 13A may be 40 μm or 15 μm.

The upper limit of each of the first and second widths WS1 and WS2 of the inner fine wires 13A2 may be 40 μm, 20 μm or 15 μm. When the widths WS1 and WS2 of the inner fine wires 13A2 are 40 μm or less, the effects obtained when the conditions 1 and 2 are satisfied can be enhanced. When the widths WS1 and WS2 are 20 μm or less, the effects obtained when the conditions 1 and 2 are satisfied can be further enhanced.

The upper limit of each of the first and second widths WS1 and WS2 of the outer fine wires 13A1 may be 40 μm, 20 μm or 15 μm. When the widths WS1 and WS2 of the outer fine wires 13A1 are 40 μm or less, the effects obtained when the conditions 1 and 2 are satisfied can be enhanced. When the widths WS1 and WS2 are 20 μm or less, the effects obtained when the conditions 1 and 2 are satisfied can be further enhanced.

The spring member 10 may have a thickness of 120 μm or more and 200 μm or less. This thickness of the spring member 10 is the distance between the first and second surfaces 10S1 and 10S2. When the thickness of the spring member 10 is within the above range, it is possible to ensure that the effects resulting from the fine wires 13A satisfying the conditions 1 and 2 are obtained.

The ratio (T/W) of the thickness (T) of the spring member 10 to the width (W) of a fine wire 13A is the aspect ratio of the fine wire 13A. The aspect ratio of the inner fine wires 13A2 may be, for example, 3 or greater and 20 or less. The aspect ratio of the inner fine wires 13A2 may have a lower limit of 6, 8 or 12. The aspect ratio of the inner fine wires 13A2 may have an upper limit of 13, 10 or 5. Note that an inner fine wire 13A2 may have different aspect ratios in the thickness direction of the spring member 10. That is, in the thickness direction of the spring member 10, the aspect ratio at a first position, which can be any position in the thickness direction, and the aspect ratio at a second position different from the first position can be different from each other. The number of values that one inner fine wire 13A2 can take may be 3 or more and 20 or less.

The aspect ratio of the outer fine wires 13A1 may be, for example, 3 or greater and 20 or less. The aspect ratio of the outer fine wires 13A1 may have a lower limit of 6, 8 or 12. The aspect ratio of the outer fine wires 13A1 may have an upper limit of 13, 10 or 5. Note that an outer fine wire 13A1 may have different aspect ratios in the thickness direction of the spring member 10. That is, in the thickness direction of the spring member 10, the aspect ratio at a first position, which can be any position in the thickness direction, and the aspect ratio at a second position different from the first position can be different from each other. The number of values that one outer fine wire 13A1 can take may be 3 or more and 20 or less.

When the widths of the inner and outer fine wires 13A2 and 13A1 satisfy the conditions 1 and 2, it is possible to suppress the occurrence of a local penetrating portion or breakage near the centers of the fine wires 13A in the thickness direction during etching and to suppress deformation of the fine wires 13A during driving, over a wide range of aspect ratios of the fine wires 13A.

In the direction in which the fine wires 13A are arranged, the distance between the centers of the fine wires 13A is a pitch P of the fine wires 13A. The pitch P may be the distance between the centers of the fine wires 13A on the first or second surface 10S1 or 10S2. In either case, the pitch P takes a similar value. For example, the pitch P may be 200 μm or more and 500 μm or less, and preferably it is 240 μm or more and 400 μm or less.

The spring member 10 is formed from a metal having a hardness high enough to achieve the spring load or deflection required for the spring member 10. For example, the spring member 10 may be formed from stainless steel alloy or copper alloy. The stainless steel alloy may be, for example, a stainless steel alloy in accordance with JIS G 4313:2011, “Cold rolled stainless steel strip for springs”. The copper alloy may be, for example, a copper alloy specified in JIS H 3130: 2018, “Copper beryllium alloy, copper titanium alloy, phosphor bronze, copper-nickel-tin alloy and nickel silver sheets, plates and strips for springs”.

The spring member 10 may contain any selected from the group consisting of a stainless steel alloy, beryllium copper, a copper-nickel-tin alloy, phosphor bronze, a Corson alloy, and titanium copper. The spring member 10 is preferably formed using any material selected from this group. Since the spring member 10 can have high hardness, the durability of the spring member 10 can be improved.

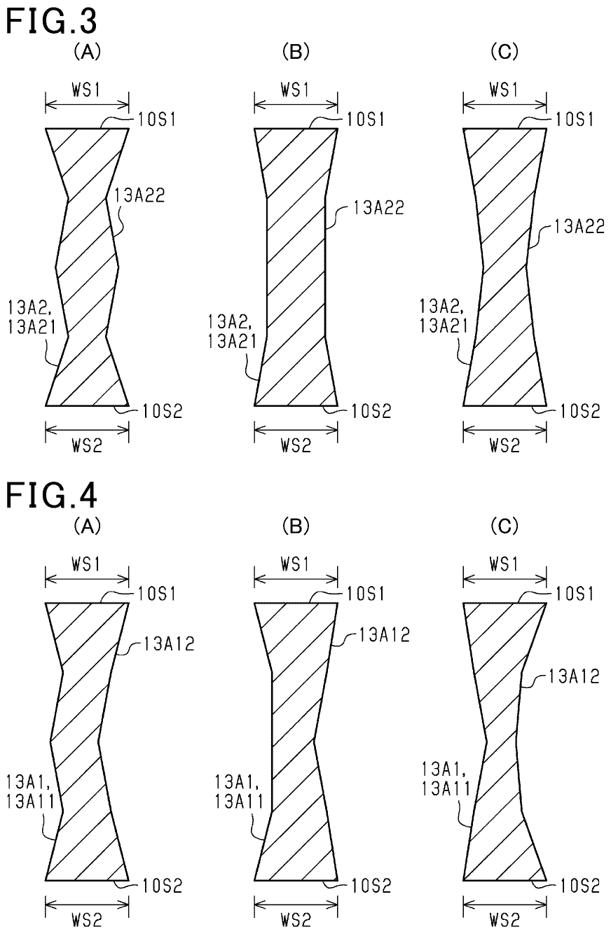

FIG. 3(A) to 3(C) show examples of the cross-sectional shape of an inner fine wire 13A2. FIG. 3(A) to 3(C) are examples of the shape of an inner fine wire 13A2 in a cross section taken along the line II-II in FIG. 1.

As shown in FIG. 3(A) to 3(C), each inner fine wire 13A2 has a pair of side surfaces extending in the thickness direction of the spring member 10, namely, a first side surface 13A21 and a second side surface 13A22. In each inner fine wire 13A2, the second side surface 13A22 has a shape obtained by laterally inverting the shape of the first side surface 13A21.

Each inner fine wire 13A2 is adjacent to another fine wire 13A on both sides in the direction in which the fine wires 13A are arranged. Furthermore, in the direction in which the fine wires 13A are arranged, the distances between the fine wires 13A are substantially the same. Therefore, when the metal foil that forms the spring member 10 is wet-etched, the side surfaces 13A21 and 13A22 of each inner fine wire 13A2 are formed by substantially the same amounts of etching solution flowing in substantially the same manner. As a result, in a cross section perpendicular to the first surface 10S1, the second side surface 13A22 has a shape obtained by laterally inverting the shape of the first side surface 13A21.

In the example shown in FIG. 3(A), each of the side surfaces 13A21 and 13A22 has a folded line-shape with a plurality of bending points in the thickness direction of the spring member 10. Each of the side surfaces 13A21 and 13A22 has a shape in which two V-shaped portions, both recessed toward the center of the inner fine wire 13A2, are stacked in the thickness direction of the spring member 10.

In the example shown in FIG. 3(B), each of the side surfaces 13A21 and 13A22 is defined by a pair of inclined lines and a straight line extending between them in the thickness direction of the spring member 10. Of the pair of inclined lines, the inclined line connected to the first surface 10S1 has an inclination that reduces the width of the inner fine wire 13A2 in the direction from the first surface 10S1 toward the second surface 10S2. Of the pair of inclined lines, the inclined line connected to the second surface 10S2 has an inclination that reduces the width of the inner fine wire 13A2 in the direction from the second surface 10S2 toward the first surface 10S1.

In the example shown in FIG. 3(C), each of the side surfaces 13A21 and 13A22 is V-shaped with a single bending point in the thickness direction of the spring member 10. The first side surface 13A21 is V-shaped and recessed from the first side surface 13A21 toward the second side surface 13A22. The second side surface 13A22 is V-shaped and recessed from the second side surface 13A22 toward the first side surface 13A21. As a result, the inner fine wire 13A2 has a shape in which the approximate center in the thickness direction of the spring member 10 is narrowed.

FIG. 4(A) to 4(C) show examples of the cross-sectional shape of an outer fine wire 13A1. FIG. 4(A) to 4(C) are examples of the shape of an outer fine wire 13A1 in a cross section taken along the line II-II in FIG. 1. Further, the outer fine wires 13A1 shown in FIG. 4(A) to 4(C) are examples of the right-hand outer fine wire 13A1 of the pair of outer fine wires 13A1 in FIG. 2. In FIG. 2, the left-hand outer fine wire 13A1 has a shape obtained by laterally inverting the shape of the right-hand outer fine wire 13A1.

As shown in FIG. 4(A) to 4(C), each outer fine wire 13A1 has a pair of side surfaces extending in the thickness direction of the spring member 10, namely, a first side surface 13A11 at a smaller distance from the inner fine wires 13A2 and a second side surface 13A12 opposite the first side surface 13A11. In each outer fine wire 13A1, the first and second side surfaces 13A11 and 13A12 have different shapes.

In the direction in which the fine wires 13A are arranged, each outer fine wire 13A1 has an adjacent inner fine wire 13A2 on the first side surface 13A11 side, but has no adjacent fine wire 13A on the second side surface 13A12 side. Therefore, when the metal foil that forms the spring member 10 is wet-etched, the second side surface 13A12 of the outer fine wire 13A1 comes into contact with more etching solution than the first side surface 13A11 thereof. In addition, the second side surface 13A12 is formed by an etching solution that flows differently from the etching solution for forming the first side surface 13A11. As a result, in each outer fine wire 13A1, the first and second side surfaces 13A11 and 13A12 have different shapes.

As shown in FIG. 4(A), the second side surface 13A12 may be V-shaped and recessed from the second side surface 13A12 toward the first side surface 13A11. In this case, since the outer fine wire 13A1 is narrowed on at least one side surface, the rigidity of the outer fine wire 13A1 is unlikely to be excessively high.

In the example shown in FIG. 4(A), the second side surface 13A12 is V-shaped with a single bending point in the thickness direction of the spring member 10. The second side surface 13A12 is V-shaped and recessed from the second side surface 13A12 toward the first side surface 13A11. The valley of the V-shape is located at the approximate center in the thickness direction of the spring member 10. In contrast, the first side surface 13A11 has a folded line-shape with a plurality of bending points in the thickness direction of the spring member 10. The first side surface 13A11 has a shape in which two V-shaped portions, both recessed toward the center of the outer fine wire 13A1, are stacked in the thickness direction of the spring member 10. In the width direction of the spring member 10, the peak at the boundary between the two V-shaped portions of the first side surface 13A11 is aligned with the valley of the V-shaped second side surface 13A12.

In the example shown in FIG. 4(B), as in the example shown in FIG. 4(A), the second side surface 13A12 is V-shaped with a single bending point in the thickness direction of the spring member 10. The second side surface 13A12 is V-shaped and recessed from the second side surface 13A12 toward the first side surface 13A11. The valley of the V-shape is located at the approximate center in the thickness direction of the spring member 10.

In contrast, the first side surface 13A11 is defined by a pair of inclined lines and a straight line extending between them in the thickness direction of the spring member 10. Of the pair of inclined lines, the inclined line connected to the first surface 10S1 has an inclination that reduces the width of the outer fine wire 13A1 in the direction from the first surface 10S1 toward the second surface 10S2. Of the pair of inclined lines, the inclined line connected to the second surface 10S2 has an inclination that reduces the width of the outer fine wire 13A1 in the direction from the second surface 10S2 toward the first surface 10S1.

In the example shown in FIG. 4(C), the second side surface 13A12 is U-shaped and recessed from the second side surface 13A12 toward the first side surface 13A11. The second side surface 13A12 has a plurality of bending points in the thickness direction of the spring member 10. In contrast, the first side surface 13A11 is V-shaped with a single bending point in the thickness direction of the spring member 10. The first side surface 13A11 is V-shaped and recessed from the first side surface 13A11 toward the second side surface 13A12. The valley of the V-shape is located at the approximate center in the length direction of the spring member 10. In the width direction of the spring member 10, the bottom, i.e., the most recessed portion of the second side surface 13A12 is aligned with the valley of the first side surface 13A11.

The variation in the width of each fine wire 13A in the thickness direction is within ±2 μm of the average width thereof. In each fine wire 13A, the maximum width is smaller than or equal to the average width plus 2 μm, and the minimum width is greater than or equal to the average width minus 2 μm.

### Method of Producing Spring Member

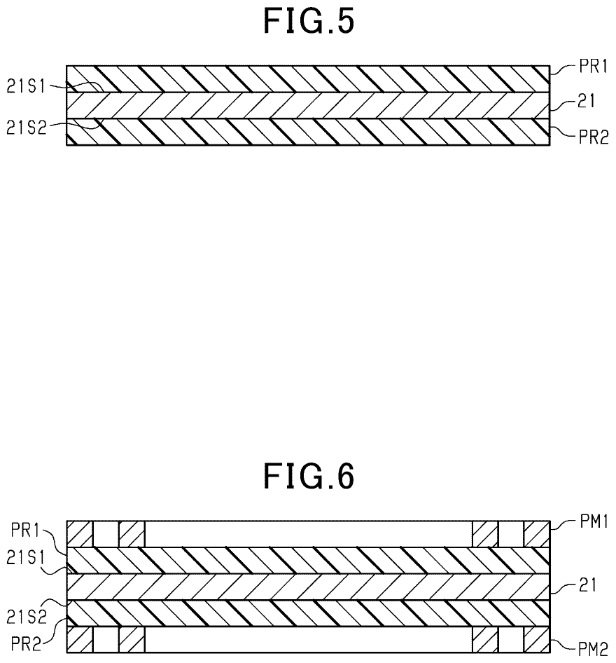

With reference to FIGS. 5 to 9, a method of producing the spring member 10 will be described.

As shown in FIG. 5, to produce the spring member 10, first, a first resist layer PR1 is formed on a first surface 21S1 of a metal foil 21, and a second resist layer PR2 is formed on a second surface 21S2 thereof. In the example described with reference to FIGS. 5 to 9, the resist layers PR1 and PR2 are formed from positive photoresist, but the resist layers PR1 and PR2 may also be formed from negative photoresist.

Next, as shown in FIG. 6, a first photomask PM1 is placed on the first resist layer PR1, and a second photomask PM2 is placed on the second resist layer PR2. Then, the first resist layer PR1 is exposed to light using the first photomask PM1, and the second resist layer PR2 is exposed to light using the second photomask PM2.

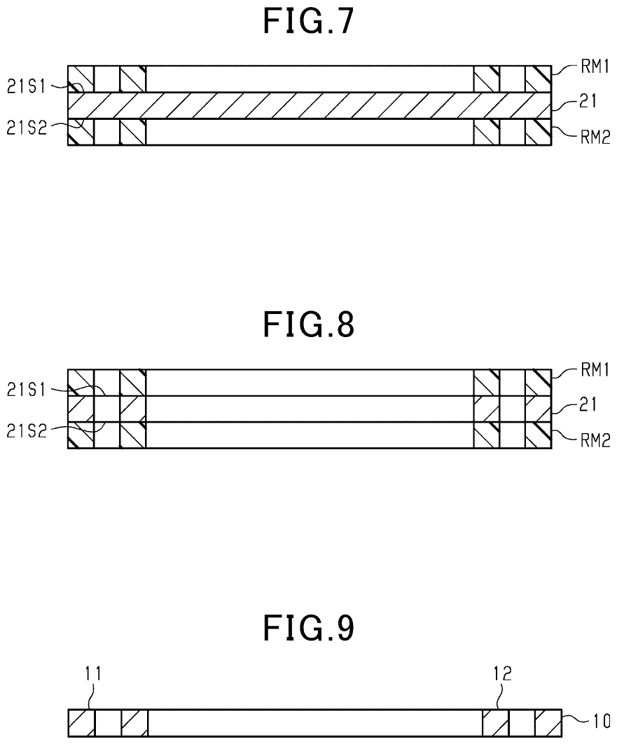

As shown in FIG. 7, the exposed resist layers PR1 and PR2 are developed, thereby forming a first resist mask RM1 from the first resist layer PR1 and a second resist mask RM2 from the second resist layer PR2.

As shown in FIG. 8, the metal foil 21 is wet-etched using the resist masks RM1 and RM2. At this time, the metal foil 21 is etched from both the first and second surfaces 21S1 and 21S2. This creates through-holes in the metal foil 21 that penetrate the metal foil 21 in the thickness direction, resulting in the formation of the outer frame portion 11, the inner frame portion 12 spaced apart from the outer frame portion 11, and the spring portion 13 that connects the inner and outer frame portions 12 and 11.

As a result, a spring member 10 that satisfies the above conditions 1 and 2 is formed, making it possible to achieve both suppression of the occurrence of a local penetrating portion or breakage near the center of each fine wire 13A in the thickness direction during etching, and suppression of deformation of the inner fine wires 13A2 caused by driving the spring member 10.

As shown in FIG. 9, the resist masks RM1 and RM2 are removed from the etched metal foil 21, and then the spring member 10 is cut out from the etched metal foil 21, thereby obtaining the spring member 10.

The metal foil 21 for forming the spring member 10 may include a base metal and a copper layer. The base metal may contain any selected from the group consisting of a stainless steel alloy, beryllium copper, a copper-nickel-tin alloy, phosphor bronze, a Corson alloy, and titanium copper. The base metal has a first surface and a second surface opposite the first surface. The copper layer may be located on at least one of the first and second surfaces of the base metal. That is, the copper layer may be located on both the first and second surfaces, or only on the first or second surface. The copper layer may be formed by, for example, vacuum deposition, sputtering, or wet plating.

When the metal foil 21 includes a base metal and one or more copper layers, the spring member 10 includes a base metal and one or more copper layers. The base metal of the spring member 10 is a part of the base metal of the metal foil 21, and the copper layer of the spring member 10 is a part of the copper layer of the metal foil 21. The base metal has a first surface and a second surface opposite the first surface. The copper layer is located on at least one of the first and second surfaces. That is, the copper layer may be located on both the first and second surfaces of the base metal, or only on the first or second surface thereof.

### EXAMPLES

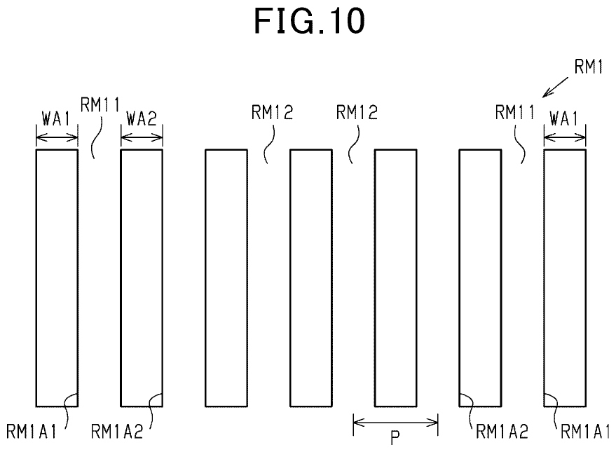

Example and Comparative Examples will be described with reference to FIGS. 10 to 13.

### Comparative Example 1-1

In Comparative Example 1-1, a metal foil 21 was prepared using a 120-μm-thick rolled material made of titanium copper. Next, the resist masks RM1 and RM2 were formed on the first and second surfaces 21S1 and 21S2 of the metal foil 21, and the metal foil 21 was wet-etched from both the first and second surfaces 21S1 and 21S2 using the two resist masks RM1 and RM2. The etching solution used in the wet etching was an aqueous solution of ferric chloride.

Note that, within a 280-mm square area of the metal foil 21, 20-mm unit square areas, each corresponding to one spring member 10, were densely packed in both the rolling direction and the width direction of the metal foil 21, thereby forming a grid pattern. Therefore, in each of the resist masks RM1 and RM2, unit patterns, each corresponding to the shape of one spring member 10, were densely packed in both the rolling direction and the width direction so as to form a grid pattern.

FIG. 10 is a plan view schematically illustrating part of the unit pattern of the first resist mask RM1. FIG. 10 schematically illustrates the part of the unit pattern corresponding to a spring portion 13 of the spring member 10. In FIG. 10, for convenience of illustration, the openings of the unit patterns are illustrated as rectangles. The second resist mask RM2 has a different position relative to the metal foil 21 from the first resist mask RM1, but has the same shape as the first resist mask RM1. Therefore, in the following, the shape of the first resist mask RM1 will be described, and the description of the shape of the second resist mask RM2 will be omitted.

As shown in FIG. 10, the unit pattern has a plurality of openings in the part corresponding to the spring portion 13. The openings include two first openings RM1A1 located at the edges in the direction in which the openings are arranged (arrangement direction), and second openings RM1A2 located between the two first openings RM1A1. In the arrangement direction, each first opening RM1A1 has a first width WA1 and each second opening RM1A2 has a second width WA2.

In the first resist mask RM1, each portion located between a first opening RM1A1 and a second opening RM1A2 in the arrangement direction is a first linear portion RM11. Each portion located between two second openings RM1A2 in the arrangement direction is a second linear portion RM12. After etching the metal foil 21, the portions covered with the first linear portions RM11 form the outer fine wire 13A1, and the portions covered with the second linear portions RM12 form the inner fine wires 13A2. Each unit pattern was formed so that, after etching the metal foil 21, six fine wires 13A would be included in a cross section perpendicular to the first surface 21S1 and perpendicular to the direction in which the fine wires 13A extend.

In the first resist mask RM1, the pitch P between any adjacent ones of the linear portions RM11 and RM12 in the arrangement direction was set to 240 μm. The first width WA1 of the first opening RM1A1 was set to 220 μm, and the second width WA2 of the second opening RM1A2 was set to 100 μm.

In addition, in plan view of the first surface 21S1 of the metal foil 21, a plurality of unit patterns were formed in each of the resist masks RM1 and RM2 so that the entirety of one unit pattern in the first resist mask RM1 overlaps the entirety of one unit pattern in the second resist mask RM2.

Using these resist masks RM1 and RM2, a plurality of etching patterns, each corresponding to the shape of the spring member 10, were formed on the metal foil 21.

### Comparative Examples 1-2 to 1-7

In Comparative Examples 1-2 to 1-7, the first width WA1 of the first openings RM1A1 was reduced and the width of the first linear portions RM11 was increased relative to those of Comparative Example 1-1. Other than that, the etching patterns of Comparative Examples 1-2 to 1-7 were obtained in the same manner as in Comparative Example 1-1.

### Comparative Example 1-8

In Comparative Example 1-8, the second width WA2 of the second openings RM1A2 was reduced and the width of the second linear portions RM12 was increased relative to those of Comparative Example 1-1. Other than that, the etching pattern of Comparative Example 1-8 was obtained in the same manner as in Comparative Example 1-1.

### Comparative Examples 1-9 and 1-10, Examples 1-1 to 1-4, and Comparative Examples 1-11 to 1-13

In Comparative Examples 1-9 and 1-10, Examples 1-1 to 1-4, and Comparative Examples 1-11 to 1-13, the first width WA1 of the first openings RM1A1 was reduced and the width of the first linear portions RM11 was increased relative to those of Comparative Example 1-8. Other than that, the etching patterns of Comparative Examples 1-9 and 1-10, Examples 1-1 to 1-4, and Comparative Examples 1-11 to 1-13 were obtained in the same manner as in Comparative Example 1-8.

### Example 1-5

In Example 1-5, the widths WA1 and WA2 of the openings RM1A1 and RM1A2 were reduced and the widths of the linear portions RM11 and RM12 were increased relative to those of Comparative Example 1-1. Other than that, the etching pattern of Example 1-5 was obtained in the same manner as in Comparative Example 1-1.

### Examples 1-6 to 1-8 and Comparative Example 1-14

In Examples 1-6 to 1-8 and Comparative Example 1-14, the first width WA1 of the first openings RM1A1 was reduced and the width of the first linear portions RM11 was increased relative to those of Example 1-5. Other than that, the etching patterns of Examples 1-6 to 1-8 and Comparative Example 1-14 were obtained in the same manner as in Example 1-5.

### Comparative Example 2-1

The etching pattern of Comparative Example 2-1 was obtained by modifying the etching pattern of Comparative Example 1-1 such that the thickness of the metal foil 21 was 150 μm, the pitch P was 300 μm, and the widths WA1 and WA2 of the openings RM1A1 and RM1A2 were increased. Other than that, the etching pattern of Comparative Example 2-1 was obtained in the same manner as in Comparative Example 1-1.

### Comparative Examples 2-2 to 2-7

In Comparative Examples 2-2 to 2-7, the first width WA1 of the first openings RM1A1 was reduced and the width of the first linear portions RM11 was increased relative to those of Comparative Example 2-1. Other than that, the etching patterns of Comparative Examples 2-2 to 2-7 were obtained in the same manner as in Comparative Example 2-1.

### Comparative Example 2-8

In Comparative Example 2-8, the second width WA2 of the second openings RM1A2 was reduced and the width of the second linear portions RM12 was increased relative to those of Comparative Example 2-1. Other than that, the etching pattern of Comparative Example 2-8 was obtained in the same manner as in Comparative Example 2-1.

### Comparative Examples 2-9 and 2-10, Examples 2-1 to 2-4, and Comparative Examples 2-11 to 2-13

In Comparative Examples 2-9 and 2-10, Examples 2-1 to 2-4, and Comparative Examples 2-11 to 2-13, the first width WA1 of the first openings RM1A1 was reduced and the width of the first linear portions RM11 was increased relative to those of Comparative Example 2-8. Other than that, the etching patterns of Comparative Examples 2-9 and 2-10, Examples 2-1 to 2-4, and Comparative Examples 2-11 to 2-13 were obtained in the same manner as in Comparative Example 2-8.

### Example 2-5

In Example 2-5, the widths WA1 and WA2 of the openings RM1A1 and RM1A2 were reduced and the widths of the linear portions RM11 and RM12 were increased relative to those of Comparative Example 2-1. Other than that, the etching pattern of Example 2-5 was obtained in the same manner as in Comparative Example 2-1.

### Examples 2-6 to 2-8 and Comparative Example 2-14

In Examples 2-6 to 2-8 and Comparative Example 2-14, the first width WA1 of the first openings RM1A1 was reduced and the width of the first linear portions RM11 was increased relative to those of Example 2-5. Other than that, the etching patterns of Examples 2-6 to 2-8 and Comparative Example 2-14 were obtained in the same manner as in Example 2-5.

### Comparative Example 3-1

The etching pattern of Comparative Example 3-1 was obtained by modifying the etching pattern of Comparative Example 1 -1 such that the thickness of the metal foil 21 was 200 μm, the pitch P was 400 μm, and the widths WA1 and WA2 of the openings RM1A1 and RM1A2 were increased. Other than that, the etching pattern of Comparative Example 3-1 was obtained in the same manner as in Comparative Example 1-1.

### Comparative Examples 3-2 to 3-7

In Comparative Examples 3-2 to 3-7, the first width WA1 of the first openings RM1A1 was reduced and the width of the first linear portions RM11 was increased relative to those of Comparative Example 3-1. Other than that, the etching patterns of Comparative Examples 3-2 to 3-7 were obtained in the same manner as in Comparative Example 3-1.

### Comparative Example 3-8

In Comparative Example 3-8, the second width WA2 of the second openings RM1A2 was reduced and the width of the second linear portions RM12 was increased relative to those of Comparative Example 3-1. Other than that, the etching pattern of Comparative Example 3-8 was obtained in the same manner as in Comparative Example 3-1.

### Comparative Examples 3-9 and 3-10, Examples 3-1 to 3-4, and Comparative Examples 3-11 to 3-13

In Comparative Examples 3-9 and 3-10, Examples 3-1 to 3-4, and Comparative Examples 3-11 to 3-13, the first width WA1 of the first openings RM1A1 was reduced and the width of the first linear portions RM11 was increased relative to those of Comparative Example 3-8. Other than that, the etching patterns of Comparative Examples 3-9 and 3-10, Examples 3-1 to 3-4, and Comparative Examples 3-11 to 3-13 were obtained in the same manner as in Comparative Example 3-8.

### Example 3-5

In Example 3-5, the widths WA1 and WA2 of the openings RM1A1 and RM1A2 were reduced and the widths of the linear portions RM11 and RM12 were increased relative to those of Comparative Example 3-1. Other than that, the etching pattern of Example 3-5 was obtained in the same manner as in Comparative Example 3-1.

### Examples 3-6 to 3-8 and Comparative Example 3-14

In Examples 3-6 to 3-8 and Comparative Example 3-14, the first width WA1 of the first openings RM1A1 was reduced and the width of the first linear portions RM11 was increased relative to those of Example 3-5. Other than that, the etching patterns of Examples 3-6 to 3-8 and Comparative Example 3-14 were obtained in the same manner as in Example 3-5.

### Fine Wire Width

The spring portions 13 of the etching patterns present on each metal foil 21 after etching were embedded using synthetic resin. Then, each embedded spring portion 13 was cut using a microtome to expose a cross section of the spring portion 13 in a plane perpendicular to the direction in which the fine wires included in the spring portion 13 extends and perpendicular to the first surface 21S1.

In the cross section of the spring portion 13, the spring width was measured at the following locations. That is, in the spring portion 13, the first width WS1 at the first surface 21S1 of the metal foil 21, the second width WS2 at the second surface 21S2 of the metal foil 21, and the widths at the three planes located between the first and second surfaces 21S1 and 21S2 of the metal foil 21 and dividing the spring portion 13 into four equal sections in the thickness direction were measured. A digital microscope (VHX-6000, manufactured by Keyence Corporation) was used to measure the widths of the spring portion 13, with the magnification of the objective lens set to 100×.

In one spring portion 13 of each metal foil 21, an average value of the second width WS2 was calculated from the two outer fine wires 13A1, and an average value of the second width WS2 was calculated from the four inner fine wires 13A2. Then, by averaging the average values of the second widths WS2 of ten spring portions 13, the average value of the second widths WS2 of the outer fine wires 13A1 and the average value of the second widths WS2 of the inner fine wires 13A2 were calculated. The resulting average values were set as the second widths WS2 of the fine wires 13A1 and 13A2 in each of the Examples and Comparative Examples.

In addition, in one spring portion 13 of each metal foil 21, an average value of the first width WS1 was calculated from the two outer fine wires 13A1, and an average value of the first width WS1 was calculated from the four inner fine wires 13A2. Then, by averaging the average values of the first widths WS1 of ten spring portions 13, the average value of the first widths WS1 of the outer fine wires 13A1 and the average value of the first widths WS1 of the inner fine wires 13A2 were calculated. The resulting average values were set as the first widths WS1 of the fine wires 13A1 and 13A2 in each of the Examples and Comparative Examples.

In addition, in one spring portion 13 of each metal foil 21, the average value of the widths at the five locations was calculated for each outer fine wire 13A1, and further the average width of the two outer fine wires 13A1 was calculated. Thus, the average width of the outer fine wires 13A1 in one spring portion 13 was calculated. Then, by averaging the average widths of the outer fine wires 13A1 of ten spring portions 13, the average width of the outer fine wires 13A1 was calculated. In addition, in one spring portion 13 of each metal foil 21, the average value of the widths at the five locations was calculated for each inner fine wire 13A2, and further the average width of the four inner fine wires 13A2 was calculated. Thus, the average width of the inner fine wires 13A2 in one spring portion 13 was calculated. Then, by averaging the average widths of the inner fine wires 13A2 of ten spring portions 13, the average width of the inner fine wires 13A2 was calculated.

### Occurrence of a Local Penetrating Portion in or Breakage of Fine Wires

After etching the metal foil 21, using the above-described digital microscope, whether all etching patterns in each metal foil 21 included fine wires 13A having a local penetrating portion near the center in the thickness direction, or broken fine wires 13A, was examined. The local penetrating portion penetrates across the pair of side surfaces of the fine wire 13A. Whether the etching patterns included fine wires 13A having penetrating portions or broken fine wires 13A was evaluated based on the following two criteria.

Pass: The etching patterns did not include any fine wires 13A having a local penetrating portion formed near their center in the thickness direction or any broken fine wires 13A.

Fail: The etching patterns included one or more fine wires 13A having a local penetrating portion formed near their center in the thickness direction and/or one or more broken fine wires 13A.

### Deformation of Fine Wires

Ten etching patterns were cut out as spring members 10 from each metal foil 21. Then, a dynamic test was carried out in which the spring portions 13 were driven while the outer frame portion 11 of the spring member 10 was fixed. After that, whether the spring members 10 include deformed fine wires 13A was evaluated based on the following two criteria. The spring members 10 were observed using the above-described digital microscope to determine whether they include deformed fine wires 13A.

Pass: The spring members 10 did not include any deformed fine wires 13A after the dynamic test.

Fail: The spring members 10 included one or more deformed fine wires 13A after the dynamic test.

### Evaluation Results

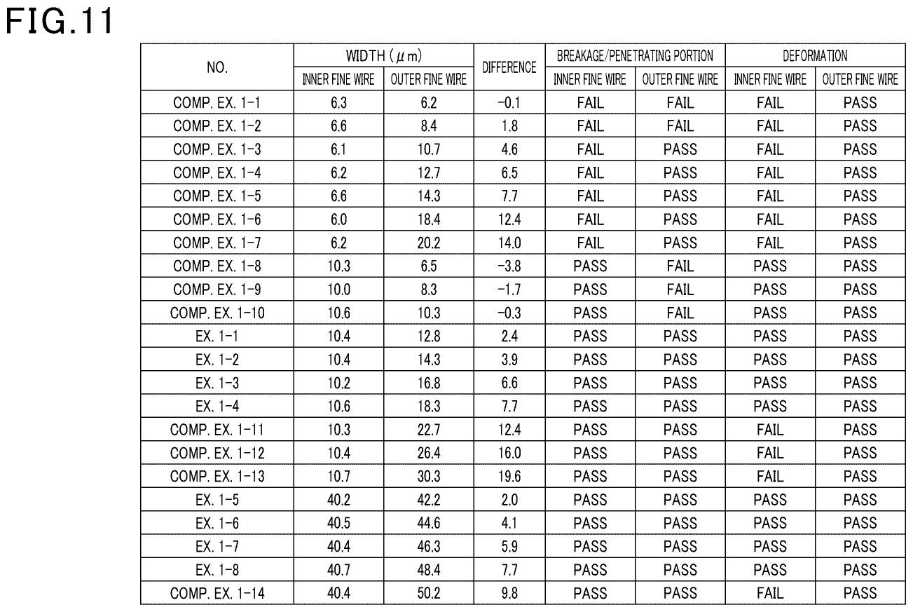

In the etching patterns of each of the Examples and Comparative Examples, the average value of the second width WS2 of each fine wire 13A, and the evaluation results as to the presence or absence of penetrating portions in or breakage of the fine wires 13A and the presence or absence of deformation of the fine wires 13A are shown in FIGS. 11 to 13.

As shown in FIGS. 11 to 13, when the width of the inner fine wires 13A2 was within the range of 6.0 μm or more and 6.6 μm or less, a local penetrating portion was observed near the centers of the inner fine wires 13A2 in the thickness direction. The local penetrating portion was formed in the narrowest part of each inner fine wire 13A2, near their center in the thickness direction of the spring member 10.

In addition, when the width of the inner fine wires 13A2 was within the range of 6.0 μm or more and 6.6 μm or less and the width of the outer fine wires 13A1 was less than 10 μm, a local penetrating portion was observed near the centers of the outer fine wires 13A1 in the thickness direction. The local penetrating portion was formed in the narrowest part of each outer fine wire 13A1, near their center in the thickness direction of the spring member 10. On the other hand, even when the width of the inner fine wires 13A2 was within the range of 6.0 μm or more and 6.6 μm or less, when the width of the outer fine wires 13A1 was 10 μm or more, no local penetrating portion or breakage was observed near the centers of the outer fine wires 13A1 in the thickness direction.

When the width of the inner fine wires 13A2 was within the range of 6.0 μm or more and 6.6 μm or less, deformed inner fine wires 13A2 were observed. On the other hand, when the width of the inner fine wires 13A2 was within the range of 6.0 μm or more and 6.6 μm or less, no deformed outer fine wires 13A1 were observed.

When the width of the inner fine wires 13A2 was within the range of 10.0 μm or more and 10.7 μm or less, and the difference obtained by subtracting the width of the inner fine wires 13A2 from the width of the outer fine wires 13A1 was 2.0 μm or more, no local penetrating portion or breakage was observed near the centers of the outer fine wires 13A1 in the thickness direction. On the other hand, when the width of the inner fine wires 13A2 was within the range of 10.0 μm or more and 10.7 μm or less, and the difference obtained by subtracting the width of the inner fine wires 13A2 from the width of the outer fine wires 13A1 was less than 2.0 μm, a local penetrating portion was observed near the centers of the outer fine wires 13A1 in the thickness direction.

When the width of the inner fine wires 13A2 was within the range of 10.0 μm or more and 10.7 μm or less, and the difference obtained by subtracting the width of the inner fine wires 13A2 from the width of the outer fine wires 13A1 was 8.0 μm or less, no deformed inner fine wires 13A2 were observed. On the other hand, when the width of the inner fine wires 13A2 was within the range of 10.0 μm or more and 10.7 μm or less, and the difference obtained by subtracting the width of the inner fine wires 13A2 from the width of the outer fine wires 13A1 exceeded 8.0 μm, deformed inner fine wires 13A2 were observed.

When the width of the inner fine wires 13A2 was within the range of 40.1 μm or more and 40.8 μm or less, and the difference obtained by subtracting the width of the inner fine wires 13A2 from the width of the outer fine wires 13A1 was 2.0 μm or more, no local penetrating portion or breakage was observed near the centers of the outer fine wires 13A1 in the thickness direction.

When the width of the inner fine wires 13A2 was within the range of 40.1 μm or more and 40.8 μm or less, and the difference obtained by subtracting the width of the inner fine wires 13A2 from the width of the outer fine wires 13A1 was 8.0 μm or less, no deformed inner fine wires 13A2 were observed. On the other hand, when the width of the inner fine wires 13A2 was within the range of 40.1 μm or more and 40.8 μm or less, and the difference obtained by subtracting the width of the inner fine wires 13A2 from the width of the outer fine wires 13A1 exceeded 8.0 μm, deformed inner fine wires 13A2 were observed.

Note that the average value of the first widths WS1 of the fine wires 13A was equivalent to the average value of the second widths WS2 shown in FIGS. 11 to 13. It was also found that the variation in the width of each fine wire 13A from the average value was ±2 μm or less.

From these results, it can be concluded that if the fine wires 13A included in the spring portion 13 satisfy the above-mentioned condition 1, the occurrence of a local penetrating portion or breakage near the center of each fine wire 13A in the thickness direction during etching can be suppressed. Furthermore, when the fine wires 13A included in the spring portion 13 satisfy the above-mentioned condition 2, deformation of the fine wires 13A caused by driving the spring member 10 can be suppressed.

As described above, according to embodiments of a spring member for a camera module, a camera module, and an electronic device, the following advantageous effects can be obtained.
(1) When the spring member 10 satisfies condition 1 and also satisfies the lower limit of condition 2, it is possible to suppress the occurrence of a local penetrating portion or breakage in the inner and outer fine wires 13A2 and 13A1 during etching. Furthermore, when the spring member 10 satisfies condition 1 and also satisfies the upper limit of condition 2, the concentration of load on the inner fine wires 13A2 caused by driving the spring member 10 can be suppressed. As a result, it is possible to suppress the deformation of the inner fine wires 13A2 caused by driving the spring member 10.
(2) It is possible to prevent each fine wire 13A from becoming excessively rigid compared to when their portion on the inner side of the first and second widths WS1 and WS2 in the thickness direction of the spring member 10 is thicker than the first and second widths WS1 and WS2.
(3) When the upper limit of the width of each fine wire 13A is 20 μm or less, the effects obtained when the widths of the fine wires 13A satisfy conditions 1 and 2 can be enhanced.
(4) Since the outer fine wire 13A1 is narrowed on at least one side surface, the rigidity of the outer fine wire 13A1 is unlikely to be excessively high.
(5) Since the spring member 10 can have high hardness, the durability of the spring member 10 can be improved.

The embodiments described above may be modified and implemented as follows.

### Spring Portion

The spring portion 13 may have a folded line-shape in which one leaf spring is folded at a plurality of bending portions as described above, or may include a plurality of independent leaf springs. When the spring member includes a plurality of independent leaf springs, each leaf spring is connected to the inner and outer frame portions.

### REFERENCE SIGNS LIST

10 . . . Spring member
10S1 . . . First surface
10S2 . . . Second surface
13 . . . Spring portion
13A . . . Fine wire
13A1 . . . Outer fine wire
13A11 . . . First side surface
13A12 . . . Second side surface
13A2 . . . Inner fine wire

1. A spring member for a camera module, the spring member comprising:
a first surface; and
a second surface opposite the first surface, wherein
the spring member further comprises, in a cross section perpendicular to the first surface, three or more fine wires, among which two of the fine wires located at both edges are outer fine wires and each of the fine wires located between the outer fine wires is an inner fine wire,
the inner fine wire has a width of 10 μm or more on each of the first and second surfaces, and,
on the first and second surfaces, the outer fine wires have widths that are greater than the width of the inner fine wire by 2μm or more and 8μm or less.

2. The spring member according to claim 1, wherein
the width of each of the fine wires on the first surface is a first width and the width of each of the fine wires on the second surface is a second width, and
the first width and the second width are the first largest width or the second largest width in a thickness direction of the spring member.

3. The spring member according to claim 2, wherein
the first width and the second width of each of the fine wires are 20 μm or less.

4. The spring member according to claim 1, wherein
each of the outer fine wires has a pair of side surfaces extending in a thickness direction of the spring member, namely, a first side surface at a smaller distance from the inner fine wire and a second side surface opposite the first side surface, and
the second side surface is V-shaped and recessed from the second side surface toward the first side surface.

5. The spring member according to claim 1, wherein the fine wires have an aspect ratio of 3 or greater and 20 or less.

6. The spring member according to claim 1, wherein the spring member has a thickness of 120 μm or more and 200 μm or less.

7. The spring member according to claim 1, wherein
the spring member comprises one selected from the group consisting of a stainless steel alloy, beryllium copper, a copper-nickel-tin alloy, phosphor bronze, a Corson alloy, and titanium copper.

8. The spring member according to claim 1, wherein
the spring member comprises a base metal comprising one selected from the group consisting of a stainless steel alloy, beryllium copper, a copper-nickel-tin alloy, phosphor bronze, a Corson alloy, and titanium copper, and
the base metal has a first surface and a second surface opposite the first surface, and the spring member further comprises a copper layer on at least one of the first surface and the second surface of the base metal.

9. A camera module comprising the spring member according to claim 1.

10. An electronic device comprising the camera module according to claim 9.
